(19) United States
(12) Patent Application Publication
(10) Pub. No.: US 2006/0219212 A1
(43) Pub. Date: Oct. 5, 2006

(54) Method for operating an internal combustion engine

(76) Inventors: Gotz Brachert, Stuttgart (DE); Rudiger Herweg, Esslingen (DE); Kai Kanning, Stuttgart (DE); Matthias Pfau, Ludwigsburg (DE); Jochen Schaflein, Stuttgart (DE); Hans-Jurgen Weiman, Oppenweiler (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 11/403,558

(22) Filed: Apr. 13, 2006

Related U.S. Application Data
(63) Continuation-in-part of application No. PCT/EP04/10280, filed on Sep. 15, 2004.

(30) Foreign Application Priority Data
Oct. 16, 2003 (DE) 103 48 139.7

(51) Int. Cl. F02B 17/00; F02B 5/00

(52) U.S. Cl. 123/295; 123/298; 123/305

(57) ABSTRACT

In an internal combustion engine, wherein a combustible fuel mix is formed in a combustion chamber of the engine by fuel and by fresh gas supplied through intake ports and combustion gases discharged through exhaust ports including intake and exhaust valves, respectively, which valves are actuated by a valve operating mechanism and a spark ignition operating mode is provided in part of the load range and an operating mode with compression ignition is provided in another part of the load range and, in the event of a change in the operating mode, the opening duration of the gas exchange valves is altered while the opening times of the exhaust valves are maintained.

This is a Continuation-In-Part Application of International Application PCT/EP2004/010280 filed Sep. 15, 2004 and claiming the priority of German application 103 48 139.7 filed Oct. 16, 2003.

### BACKGROUND OF THE INVENTION

The invention relates to a method for operating an internal combustion engine including cylinders with pistons delimiting combustion chambers to which fuel and fresh gas are supplied and from which combustion gases are discharged via controllable inlet and outlet valves.

In a reciprocating-piston internal combustion engine, a combustion chamber, in which fuel is burnt, is delimited by a longitudinally movable piston in each cylinder. Oxygen-containing fresh gas for the combustion of fuel is supplied via intake ports of the cylinders, while the combustion exhaust gases are discharged via exhaust ports. The ports are controlled by intake valves and exhaust valves which are actuated by a valve operating mechanism to carry out the cyclic charge exchange.

In a spark ignition engine, the fuel mix which is formed in the combustion chamber is ignited by the ignition spark of a cylinder spark plug projecting into the combustion chamber. An internal combustion engine operating mode known as compression ignition or chamber ignition is also known for initiating the combustion of the fuel. This operating mode offers the possibility of fuel combustion for driving the internal combustion engine with a good efficiency and a low tendency to form nitrogen-containing gases. DE 198 52 552 C2 discloses a method for operating a four-stroke internal combustion engine, in which combustion exhaust gases are retained in the combustion chamber and, as a result of the increase in temperature of the fuel/air mix, during the compression stroke of the next working cycle of the respective cylinder, a temperature of the compressed volume at which the mix is ignited is reached. Combustion exhaust gases can be retained in the cylinder by means of a valve closure overlap of the control times of the gas exchange valves. The known method seeks to control the valve closure overlap as a function of engine speed and load by means of an exhaust-gas throttle valve which is equally effective for all the cylinders of the engine.

It is also known that compression ignition, that is a fuel combustion method with spontaneous ignition of homogenous fuel/air mix, is carried out only in certain part-load ranges of the internal combustion engine because of certain limitations for this operating mode. DE 199 23 413 A1 describes a method in which the compression ignition is carried out under steady state engine operating conditions in a narrow part-load range of the engine performance map, whereas spark ignition initiated combustion is provided for higher engine loads. To change the operating mode, the known method provides for a change between valve closure overlap and valve opening overlap of the gas exchange valve control times by means of displacement of a camshaft. The camshaft actuating the valve operating mechanism for the gas exchange valves, is switchable, by means of a switching means changing the cam shape for valve opening overlap (spark ignition cycle operation) and a cam shape for exhaust gas retention in the compression ignition mode.

U.S. Pat. No. 6,336,436 B1 discloses a method for changing the operating mode of an internal combustion engine between external ignition and compression ignition, wherein the retention of exhaust gas during the compression ignition mode is realized by changing the control times of the gas exchange valves over the course of internal exhaust-gas recirculation. In this case, in the compression ignition mode, the closure time of the exhaust valve is shifted in the “late” direction compared to the external ignition mode. At the same time, the opening time of the intake valve is advanced, resulting in an opening overlap of the valve control times. The change in the control times of the gas exchange valves with a change in the operating mode is alternatively achieved in the known arrangement by a variably settable mechanism or by a camshaft having a plurality of cam profiles for the forced control of the respective valves. The known method provides for a changeover between the operating modes with a defined transition operating procedure, in which stratified mix formation is provided for by direct injection of fuel during the compression stroke. In the known method, a stable change between the combustion methods is provided for by the transition mode extending over a plurality of working cycles during a change between compression ignition and external ignition. This requires a long transition between the operating mode, since otherwise knocking and severe running irregularities in the internal combustion engine may ensue.

It is the object of the present invention to provide a method for operating an internal combustion engine which changes between an external ignition operating mode and a compression ignition operating mode wherein deteriorations in the overall efficiency of the internal combustion engine, in particular during a change in the operating modes, are avoided by structurally simple means.

### SUMMARY OF THE INVENTION

In an internal combustion engine, wherein a combustible fuel mix is formed in the combustion chamber, by fuel and fresh gas supplied through intake ports and combustion gases discharged through exhaust ports including intake and exhaust valves, respectively, which valves are actuated by a valve operating mechanism and a spark ignition operating mode is provided in part of the load range and an operating mode with compression ignition is provided in another part of the load range and in the event of a change in the operating mode the opening duration of the gas exchange valves is altered while the opening times of the exhaust valves are maintained.

The invention is based on the discovery that with the retention of exhaust-gas in the compression ignition mode, an intermediate compression of the retained exhaust gas occurs in the top dead center of the piston movement during charge exchange as a result of the control times of intake valvs and exhaust valves. This gives rise to a deterioration in the overall efficiency of the internal combustion engine, in particular if the internal combustion engine has a cam valve mechanism and the valve closure overlap is to be set using cam contours which are designed for operation of the engine in the spark ignition cycle. According to the concept of the invention, the opening duration of the gas exchange valves is reduced on switching to compression ignition mode. In this way, on the one hand a high pressure loss following the opening of the exhaust valve can be prevented by early closure of the exhaust valve with the same opening time in both operating modes. At the same time, this prevents the exhaust valve from having to be opened while the actual combustion is still ongoing in order to have sufficient time available for the required exhaust-gas retention. Furthermore, the fact that the closure time of the intake valve is identical in both operating modes and it opens later in the compression ignition mode ensures effective compression and therefore a high charge exchange efficiency.

It is expedient for the opening lift of the respective gas exchange valve to be shortened simultaneously with the reduction in the opening duration, in such a manner that the speed and acceleration of the moving valve parts remain within an acceptable range and in this way the kinematics of the valve mechanism are taken into account. When controlling the gas exchange valves using a cam valve operating mechanism, it is advantageous to switch to a cam contour with a short valve lift and short opening duration when changing the operating mode to the compression ignition. The shortening of the opening duration is adapted and determined by the corresponding contouring of the control cams in such a manner that in the compression ignition mode the required quantity of combustion exhaust gases is retained and is part of the mix formatted for the following working cycle of the cylinder.

An exemplary embodiment of the invention will be described in more detail below with reference to the accompanying drawings:

### BRIEF DESCRIPTION OF THE DRAWINGS

FIG. 1 shows a section of a reciprocating-piston internal combustion engine,

FIG. 2 shows a graph illustrating the valve lift, the valve speed and the valve acceleration of the gas exchange valves during a working cycle.

### DESCRIPTION OF AN EXEMPLARY EMBODIMENT

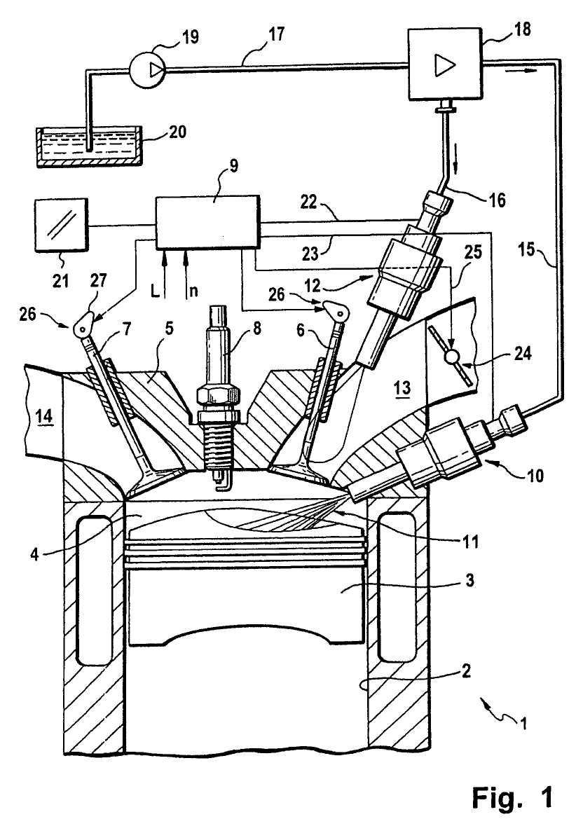

FIG. 1 shows a reciprocating-piston internal combustion engine 1, in each of whose cylinders 2 there is arranged a longitudinally movable reciprocating piston 3 which delimits a combustion chamber 4 that is closed off by a cylinder head 5 attached to the cylinder 2. A mix of fuel and combustion air is formed in the combustion chamber 4 and burnt in order to drive the reciprocating piston 3. At least one intake port 13 and an exhaust port 14 are formed in the cylinder head 5. Oxygen-rich fresh gas is supplied through the intake port 13, and the combustion exhaust gases are discharged from the combustion chamber through the exhaust port 14. Gas exchange valves 6, 7, which are driven by a valve operating mechanism 26 and, depending on the nature of the four-stroke method, cyclically open the intake port 13 and with regard to the exhaust valve 7 open the exhaust port 14, are provided for the purpose of controlling the charge exchange. To meter in the fuel required for combustion, each cylinder is provided with an injector 10, which is in each case arranged in the cylinder head 5 and directs a fuel jet 11 directly into the combustion chamber 4. As an alternative or in addition, an induction pipe injector 12, which releases fuel into the intake port 13, is provided. Fuel is supplied to the direct injector 10 and the induction pipe injector 12 via fuel lines 15, 16 of one or more fuel pumps 18 to which fuel is supplied from a fuel tank 20 via a supply line 17.

In the present exemplary embodiment, the fuel pump is a high-pressure pump and provides fuel at a high injection pressure to the direct fuel injection valve 10. In the exemplary embodiment shown here, a supply pump 19 is arranged in the supply line 17. The metering of fuel is accomplished by a control unit 9 as a function of the operating point of the internal combustion engine. To transmit injection commands, the control unit 9 is connected to the induction pipe injector 12 via a signal line 22 and to the direct injection valve 10 via a signal line 23. The control unit 9 determines the momentary operating point of the internal combustion engine as a function of operating parameters which are measured on an ongoing basis. In the present exemplary embodiment the load L and speed n of the internal combustion engine 1 are measured and stored control values are taken from an engine performance graph memory 21 in order to determine the engine operating point and select the associated control commands. The control unit 9 also sets the position of a throttle valve 24 arranged in the intake port 13. The mix in the combustion chamber 4 is configured by the setting of the throttle valve 24 and the associated effects on the fresh gas stream and the pressure in the intake port 13 as well as the injection parameters used to meter in the fuel. Depending on the operating point of the engine, it is possible to form a lean mix with, for example, stratified mix formation by direct fuel injection during the compression stroke of the piston 3 or to form a homogenous mix with a stoichiometric mix composition.

In higher load ranges, the internal combustion engine is operated with external ignition in the manner of a spark-ignition (Otto) engine, in which case the mix formed in the combustion chamber 4 is ignited by the ignition spark of a spark plug 8 arranged in the cylinder head 5. Operation with compression ignition is provided for in lower to medium load ranges. In this operating mode, which is also referred to as chamber combustion method, combustion exhaust gas can be retained in the combustion chamber 4 for admixing with the fresh gas of the next working cycle to a sufficient extent, by means of a suitable control of the gas exchange valves 6, 7, providing for a rise of the combustion chamber temperature so that spontaneous ignition of the charge, which has been heated by the compression by the piston 3, can take place. To switch between the external ignition mode and the compression ignition mode, the control unit 9 acts on the controllable valve operating mechanism 26 of the gas exchange valves 6, 7 in an appropriate way. The valve operating mechanism 26 provided may be a variably copntrollable valve operating mechanism, for example an electromechanical or electrohydraulic valve control, by means of which the control times, i.e. opening and closure times, and therefore the opening duration of the gas exchange valves, can be adjusted as required. In the present exemplary embodiment, the valve operating mechanism 26 provided is a cam control mechanism, in which the cam contours of control cams 27 driven by a camshaft cyclically lift the gas exchange valves off their valve seats. To switch the valve control to change the operating modes between external ignition mode and compression ignition mode, the cam valve mechanism 26 is provided with switching means, which are described in more detail below.

The configuring of the working gas and the associated retention of exhaust gases in the combustion chamber during the compression ignition mode according to the invention is controlled by adjusting the opening duration of at least one of the gas exchange valves when the operating modes are switched. The operating time of the exhaust valve 7 and the closure time of the intake valve 6 are identical in both operating modes. When the engine is switched to the compression ignition mode, the opening duration of the gas exchange valves is reduced. If the gas exchange valves are driven by a variably settable valve mechanism, such as an electromechanical or electrohydraulic valve control, the control unit 9 effects the corresponding resetting of the cyclical control times. In the present exemplary embodiment of an internal combustion engine with a cam actuated valve operating mechanism 26, a switch to a cam contour with a reduced opening duration is initiated in the event of a change from an external ignition mode to a compression ignition mode.

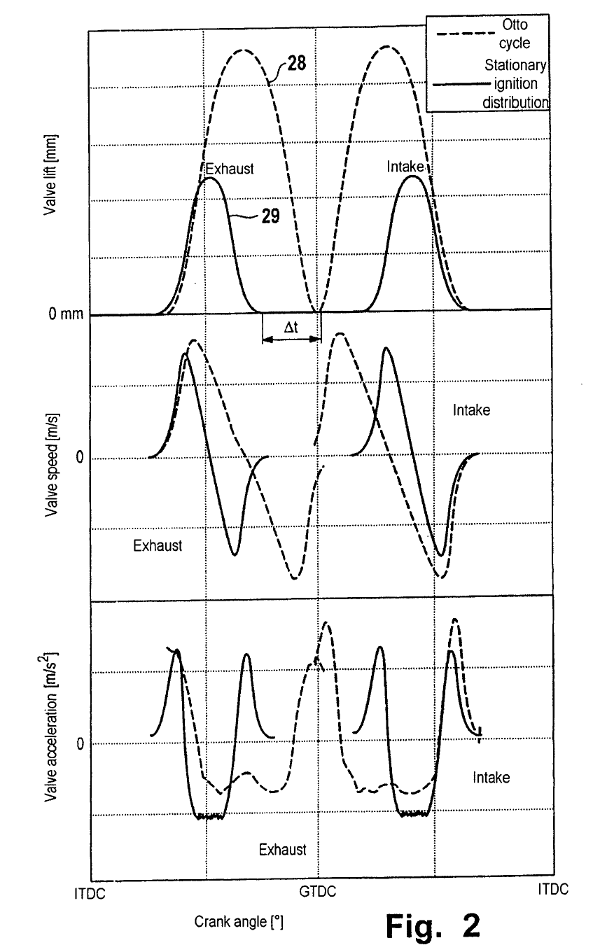

FIG. 2 shows a graph wherein the working cycle between the ignition top dead centers (ITDC) is plotted over the crank angle. Specifically the top graph illustrates the profile of the opening lift of the gas exchange valves, the middle diagram illustrates the valve speed of the intake and exhaust valves and the bottom diagram illustrates the acceleration of the moving valve parts. The curve illustrated in dashed lines corresponds to the valve lift or valve speed and acceleration in the external ignition mode (Otto cycle), whereas the solid line in each case corresponds to the compression ignition mode (stationary ignition distribution).

In the present exemplary embodiment, with a change in the operating mode, the opening durations of the exhaust valve and the intake valve are altered by a time Δt, and specifically are reduced in the event of a change from the external ignition mode to the compression ignition mode (stationary ignition distribution). The opening time of the exhaust valve and the closure time of the intake valve are identical in both operating modes. It is ensured that, in the compression ignition mode, the required residual gas quantity is retained in the combustion chamber in order to achieve the increase in temperature and the compression pressure required for spontaneous ignition. The cam contour is determined in such a manner that, in the external ignition mode, the lift of the respective valve is reduced when the engine is switched to the compression ignition mode, resulting in a cam curve 29 which is reduced for the compression ignition mode (stationary ignition distribution) compared to the cam curve 28. The reduction in the opening lift ensures that the valve speed and valve acceleration do not significantly exceed the respective profiles of these parameters in the external ignition mode. The change in the operating mode of the internal combustion engine to the compression ignition mode can therefore be realized by switching to a cam contour with shorter opening times and reduced opening lift, which can be accomplished with simple kinematic means.

What is claimed is:

1. A method for operating an internal combustion engine (1), having cylinders (2) including each a longitudinally movable piston (3) delimiting a combustion chamber (4) to which fuel and fresh gas are supplied to form a combustible fuel mix, the fresh gas being supplied through intake ports (13) and combustion exhaust gases being discharged through exhaust ports (14), intake valves (6) and exhaust valves (7) disposed in the intake and, respectively, exhaust ports (13, 14) for controlling the cyclic charge exchange, and a valve operating mechanism (26), for operating the valves (6, 7) in an operating mode with external ignition, in which the fuel mix is ignited by a spark plug (8), and which is provided in part of the load range of the internal combustion engine (1), and an operating mode with compression ignition, in which the control of the gas exchange valves (6, 7) is altered in such a manner that combustion exhaust gases are retained in the combustion chamber (4) and participate in the formation of the fresh gas mix during the following working cycle of the cylinder (2), said method comprising the step of adjusting, during a change in the operating modes, the opening duration of at least one of the gas exchange valves (6, 7) in such a way that the opening time of the exhaust valve (7) and the closing time of the intake valve (6) are maintained approximately identical in both operating modes.

2. The method as claimed in claim 1, wherein the opening duration of the gas exchange valves (6, 7) is reduced when the engine is switched to the compression ignition mode.

3. The method as claimed in claim 2, wherein the opening lift of the gas exchange valves (6, 7) is reduced in the compression ignition mode.

4. The method as claimed in claim 1, wherein the gas exchange valves (6, 7) are controlled by a cam type valve operating mechanism (26), and in the event of a switch in the operating mode to the compression ignition mode, there is a switch to a cam contour (27) with a small valve lift and a short opening duration.
